(19) United States
(12) Patent Application Publication
(10) Pub. No.: US 2016/0196396 A1
(43) Pub. Date: Jul. 7, 2016

(54) QUALITY VALUE UNIT SYSTEM AND METHOD

(71) Applicant: Quality Health Ideas, Inc., Wilbraham, MA (US)

(72) Inventor: Philip F. Gaziano, Wilbraham, MA (US)

(73) Assignee: Quality Health Ideas, Inc., Wilbraham, MA (US)

(21) Appl. No.: 14/987,947

(22) Filed: Jan. 5, 2016

Related U.S. Application Data
(60) Provisional application No. 62/099,740, filed on Jan. 5, 2015.

(51) Int. Cl. G06F 19/00

(52) U.S. Cl. CPC G06F 19/328; G06F 19/327

(57) ABSTRACT

An apparatus and method for rewarding medical care provider behavior, comprises computer instructions for assigning one or more value units according to predictive value of tasks performed by a medical care provider, presenting a screen to the medical care by which the medical care provider may record tasks that are performed, rewarding the one or more value units for each task that is performed, recording the rewarded one or more value units, and determining compensation for the medical care provider based on the number of value units that are rewarded.

### RELATED APPLICATION INFORMATION

This Application claims priority from Provisional Application Ser. No. 62/099,740, entitled “Quality Value Unit System And Method”, filed Jan. 5, 2015, the contents of which are herein incorporated by reference in its entirety.

### FIELD OF THE INVENTION

The invention relates to quality value unit system and method. Specifically, the system and method aggregates, organizes and rapidly displays critical health data, and then guides health care providers to use evidence-based and other customizable best practices to better manage care delivery.

### BACKGROUND

Prior to the introduction of the technology revolution, it was difficult to give providers timely actionable data and clinical support to make decisions with the patient in front of them. Based on the incentives built into current payment systems, there are few, if any, incentives for providers to focus on the key drivers of cost, including a patient's overall health risk, or on quality and prevention. Furthermore, it was difficult to track those activities in real time so that feedback and rewards could be given in a timeframe that encouraged desired care delivery improvements.

The existing RBRVS system pays physicians based on effort (either physical or mental) in the form of relative value units (RVUs). However, this RVU-based system does not necessarily align payments with improvements in health. Few incentives are given for the management of populations or for reductions in the cost of care for the same or greater quality.

The system and method of the present invention solves these and other problems in the prior art.

### SUMMARY OF THE INVENTION

According to one preferred embodiment, a computerized system for rewarding medical care provider behavior, comprises: a server having a processor; a first set of computer instructions executable on the processer for assigning one or more value units according to predictive value of tasks performed by a medical care provider; a second set of computer instructions executable on the processor for presenting a screen to the medical care by which the medical care provider may record tasks that are performed; a third set of computer instructions executable on the processor for rewarding the one or more value units for each task that is performed; and a fourth set of computer instructions executable on the processor for recording the rewarded one or more value units, and for determine compensation for the medical care provider based on the number of value units that are rewarded.

According to another preferred embodiment, a method for rewarding medical care provider behavior, comprises: assigning one or more value units according to predictive value of tasks performed by a medical care provider; presenting a screen to the medical care by which the medical care provider may record tasks that are performed; rewarding the one or more value units for each task that is performed; recording the rewarded one or more value units; and determining compensation for the medical care provider based on the number of value units that are rewarded.

### BRIEF DESCRIPTION OF THE DRAWINGS

FIG. 1 is a diagrammatic overview of a network system that may be used to operate one embodiment of the invention;

FIG. 2 is a block diagram illustrating selected components of a server according to the embodiment of FIG. 1;

FIG. 3 is a diagram illustrating selected components of the server and database structure according to the embodiment of FIG. 1;

FIG. 4 is a flow diagram describing steps executed by the CareScreen™ software program and server according to the embodiment of FIGS. 1-3; and

FIG. 5 is a diagram of an exemplary patient encounter screen used in CareScreen™.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

### Network System Overview

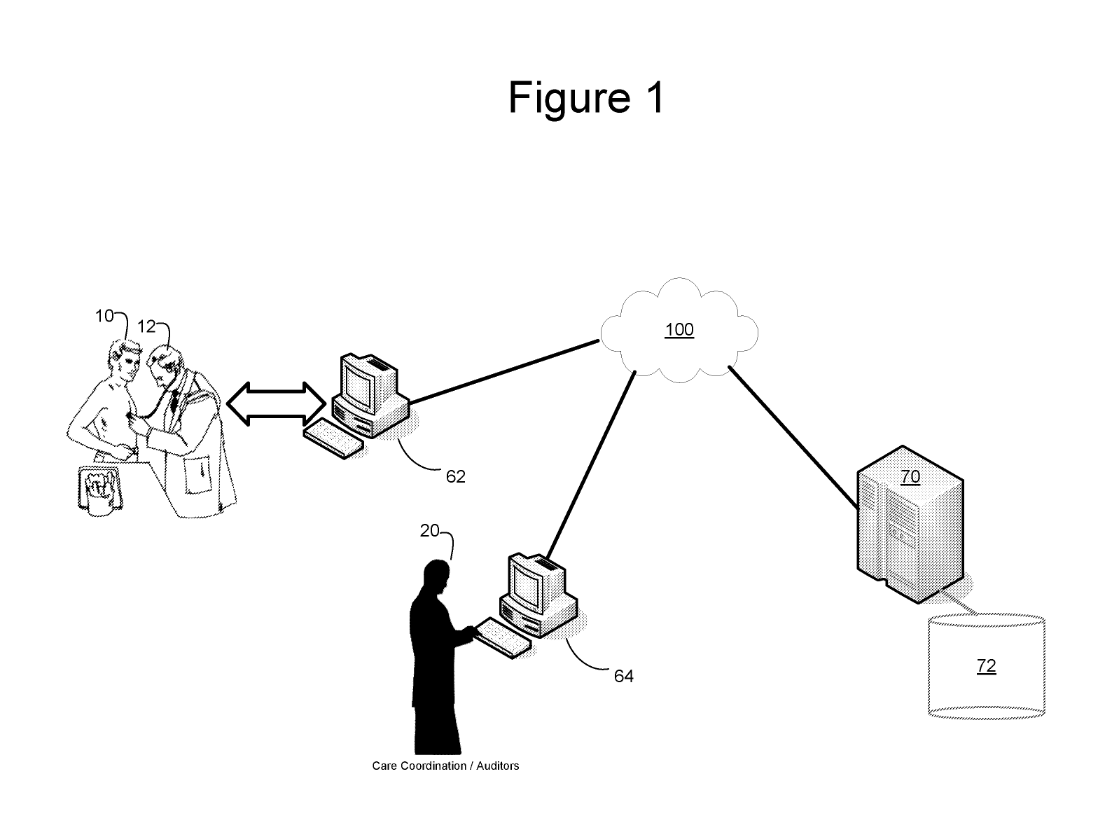

With reference to FIG. 1, a diagrammatic overview of network platform that may be used in one embodiment is shown. In one embodiment, a server computer 70 may comprise one or more complex instruction set computers (CISCs) or one or more reduced instruction set computers (RISCs). The server 70 may comprise a network connector that connects the server computer to a wide area network (WAN) 100. The WAN may comprise, for example, the Internet.

In one embodiment, the Internet 100 may thus provide for secure connections with the server computer 70 to electronic devices 62, 64 connected to the Internet 100. Said electronic devices 62, 64 may include, by way of example and not by way of limitation, one or more personal computers or mobile electronic devices connected to Internet 100 via router through a local area network, fiber optic connection, copper cable connection, dial-up connection, ISDN connection, wifi or a cellular network, digital 2G, 3G, 4G, WMAX, or other cellular network, connection, or the like. In this regard, each electronic device 62, 64 may include, by way of example and not by way of limitation, a personal computer, a laptop computer, a notebook computer, a tablet, a personal mobile communicator or cellular phone, smart phone, two-in-one, or any personal digital device.

One subset of electronic devices may each comprise a care provider's electronic device 62 used by care providers such as primary care providers (PCPs) and the like. However, care providers other than PCPs may also use the care provider's electronic device 62 with the system described herein many embodiments, and all such PCPs and non-PCPs using the care provider's electronic device 62 shall be collective called care providers 12 herein. Further, care coordinators/auditors terminals 64 are also provided so that care coordinators/auditors 20 may also perform their functions for the system and method described herein.

### Server And Database Component Structure

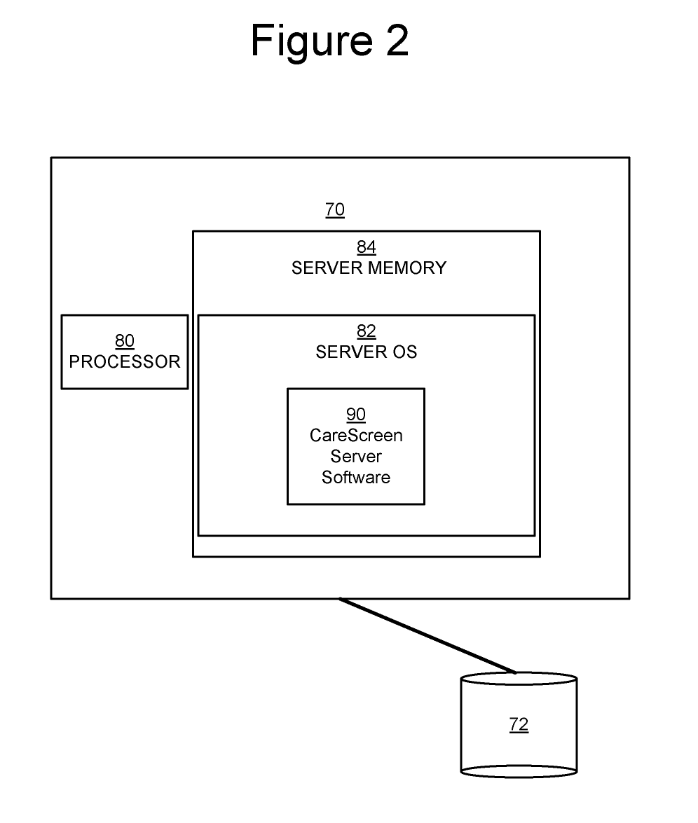

With reference to FIG. 2, selected components of the server 70 are shown according to the embodiment of FIG. 1. Different types of servers 70 may have different operating systems 82 and other hardware components, but they typically have certain common features. By way of example, and not by way of limitation, sever 70 may include a processor 80, and an operating system 82 loaded in memory 84 configured to execute on the processor 80. A memory storage device 72 may further be included to store both application code for applications, and application data, as well as database data. One of those applications may comprise the CareScreen™ server software.

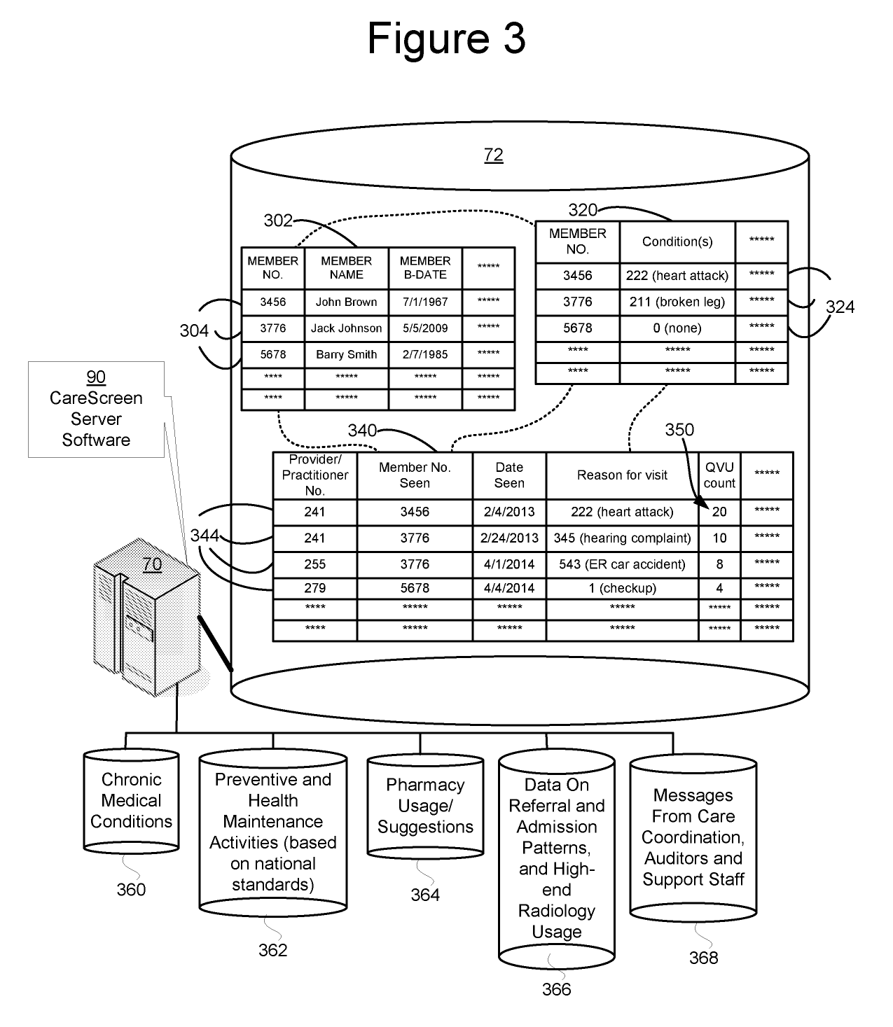

With reference to FIG. 3, a diagram illustrating selected components of the server 70 and database structure is shown according to the embodiment of the embodiment of FIG. 1 shown. In one embodiment, the server 70 may comprise one or more sets of computer instructions, or software, that may comprise an on-call software program 76. Server 70 may further comprise one or more storage devices 72 for storing one or more databases. One database table 302 may include records 304 associated with member/patient and care provider information. For example, in each record 304, general patient information may be stored, such as, by way of example and not by way of limitation, each patient's member number, name, birthdate, and the like.

Another related table 320 may include, by way of example, and not by way of limitation, patent condition records 324. Keyed to table 302 by member number, each of the patent condition records may contain information regarding chronic or temporary medical conditions of each patient.

Yet another table 340 may include, by way of example and not by way of limitation, a quality value unit (QVU) counter table. Table 340 may store multiple records for each provider 12 to store a number of QVU™ s 350 that are accumulated with each patient encounter in each record 344. For example, each record 344 may contain the provider number for the provider in the patient encounter, the member number indicating the patient 10, the date of the patient encounter, the reason for the patent encounter, and the number of QVU points 350 earned during the patient encounter. Those of skill in the art, including care providers 12, would recognize that a patient encounter does not necessary have to involve a physical patient visit. Often, in this new age of technology, the patient 10 may either be physically present for a physician visit, or the physician visit may be done by Skype®, telephone, or other remote means. Further, some patient encounters in which the provider 12 may earn QVU points 350 may not even involve the patient 10. For example, a provider's mere act of following up on test results or checking other things in the patient's chart outside the presence of the patient 10 may also qualify to earn the care provider 12 points QVU points 350.

### Description Of The CareScreen™ Software

In one embodiment, the CareScreen™ software 90 (also referred to herein as simply “CareScreen”) may comprise a web-based data management and data sharing tool (with embedded analytics and decision support) developed by Quality Health Ideas, Inc. (QHI) of Springfield, Massachusetts. It aggregates, organizes and rapidly displays critical health data, and then it guides health care providers (12 in FIG. 1) to use evidence based and other customizable best practices to better manage care delivery. This improves both the overall health in a well population and outcomes for those with costly chronic conditions. This tool: directs attention to necessary preventative actions, encourages care coordination, standardizes medication use, and improves referral patterns.

CareScreen™ 90 is designed to be used with any and all practices, and any and all health records, and does not require electronic medical records (EMR) or other information technology (IT) infrastructure to provide population management functionality. These functions and their associated decision support are not generally available in EMRs or other analytic options. The data and suggested provider actions in CareScreen™ 90 are displayed on a single web page viewable in tandem with providers' medical records, and even a provider using paper records can use CareScreen™ 90 effectively. In one embodiment, as a cloud based system, costs for (and time investments for) implementation are very low, and since the data and instructions remain on the server 70 (and not in the provider EMR—unless providers chose) concerns about liability are reduced resulting in higher provider acceptance of the tool.

CareScreen™ 90 collects and analyses data from multiple sources, including provider 12 input, into the tool, office medical records, hospital records and data, outside facilities, health care information exchange (HIE) data, centers for Medicare and Medicaid services (CMS), and payor data. Unlike traditional EMRs or health information exchanges, CareScreen™ 90 filters the enormous amount of data available to providers and presents key information in a familiar and actionable format to be used at the point of care. CareScreen™ 90 is also a smart system that evolves with the providers', members', groups', and networks' behavior. CareScreen™ 90 has modules for providers, managers (20 in FIG. 1), and health plans, as well as HIE systems and functions with bundled payment and post-acute tools.

The use of CareScreen™ 90 has been shown to improve the quality of care delivered, improve care management, enhance patient 10 satisfaction, improve appropriate utilization of clinical resources, reduce risks and liability, and reduce unnecessary costs. Most importantly, CareScreen™ 90 allows providers 12 to effectively manage care, while enhancing satisfaction.

### The Quality Value Unit (QVU)

To effectively track quality-based activities, and to reward providers 12 for such activities the CareScreen™ system 90 includes use of quality value unit (QVU™) points (350 in FIG. 3). Developed by QHI along with the CareScreen™ 90 tools to track them and the clinical support to maintain and support them, the QVU™ system has predictive value and quickly and consistently modifies practices of the providers 12.

The QVU™ 350 point system works to change provider behavior through aligning payment incentives with the quality of care delivered. QVUs have predictive value for tasks that may be performed during patient care. In addition to being paid standard fee-for-service payments, a provider 12 can be paid additional QVU™ payments if they use CareScreen™ with each visit and follow suggested instructions about reviewing data and considering options. The provider must attest to reviewing each of five areas within CareScreen™ 90, all of which are on the single provider/member page, and that are there to improve savings and quality. These areas of attention displayed on CareScreen™ 90 include: (a) chronic medical conditions, (b) preventive and health maintenance activities which are based on national standards (such as CMS and NCQA requirements) and other quality measures, (c) pharmacy usage with suggested changes, (d) data on referral and admission patterns and high-end radiology usage, and (e) messages from care coordination, auditors and support staff. For example, a provider can accrue and be paid for QVU™ activities according to the following program steps.

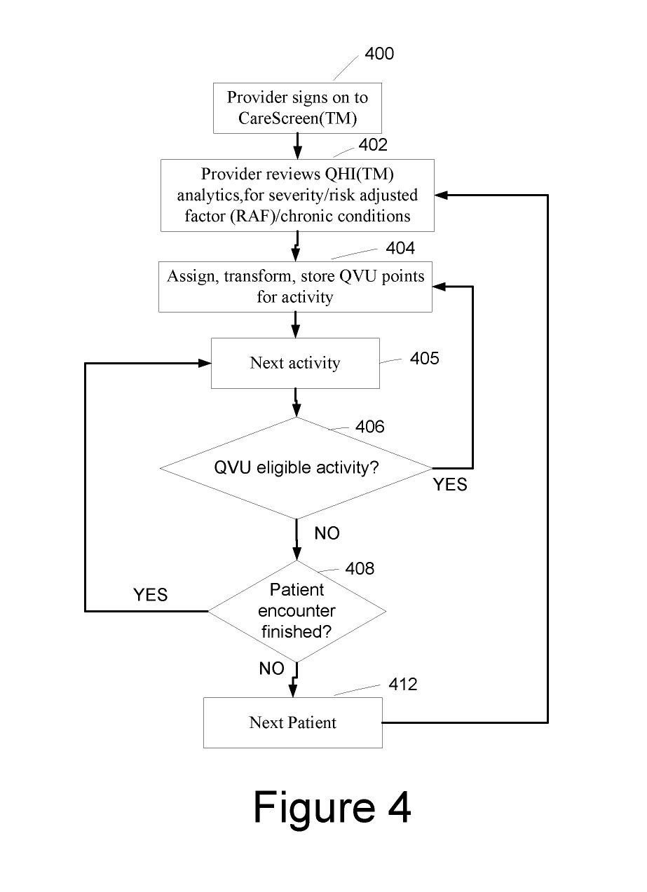

With reference to FIG. 4, a flow diagram describing steps executed by the CareScreen™ software program 90 and server 70 according to the embodiment of FIGS. 1-3 is shown. It should be recognized by those of skill in the art that some steps may be performed on the server computer 70 and/or locally on the electronic devices 62, 64 depending on sharing of resources, communication bandwidth, and other factors for application efficiency. The steps will be described with this understanding.

In step 400, the provider 12 may sign onto CareScreen™ and review its suggestions during each visit. In one example, the provider 12 may get, e.g., 1 QVU™ point 350. In step 402, the provider 12 may review QHI™ analytics for severity/risk adjusted factor (RAF)/chronic conditions, for which, in step 404, the provider may, by way of example, earn one to ten QVU™. In one embodiment, the QVU™ points 350 earned and transformed in the electronic database 72 for each activity may be determined by using statistical data from outside the practitioner's practice and/or inside the practice. With reference back to FIG. 3, there may be database modules that may be used to store and provide at least some of the statistical data may include, by way of example, and not by way of limitation, a chronic medical conditions database 360, a preventive and health maintenance activities database 362 (based on national standards), a pharmacy usage/suggestions database 364, a referral and admission patterns database 366 (which includes high-end radiology usage data), and a care coordination database 368 (which contains messages from care coordinators, auditors and support staff. The data from these and other database may be regressed linearly, added to neuro networks, artificial intelligence matrices, or other statistical tools know to those skilled in the art to determine QVU™ values for activities.

The following are examples of what may be QVU™ eligible activities and examples of QVUs earned.

Review disease registry/quality metrics: 1 QVU™ point

Review pharmacy data and suggestions: 1 QVU™ point

Look at messages from case managers, chart reviewers, auditors, and/or medical directors: 1 or more QVU™ points

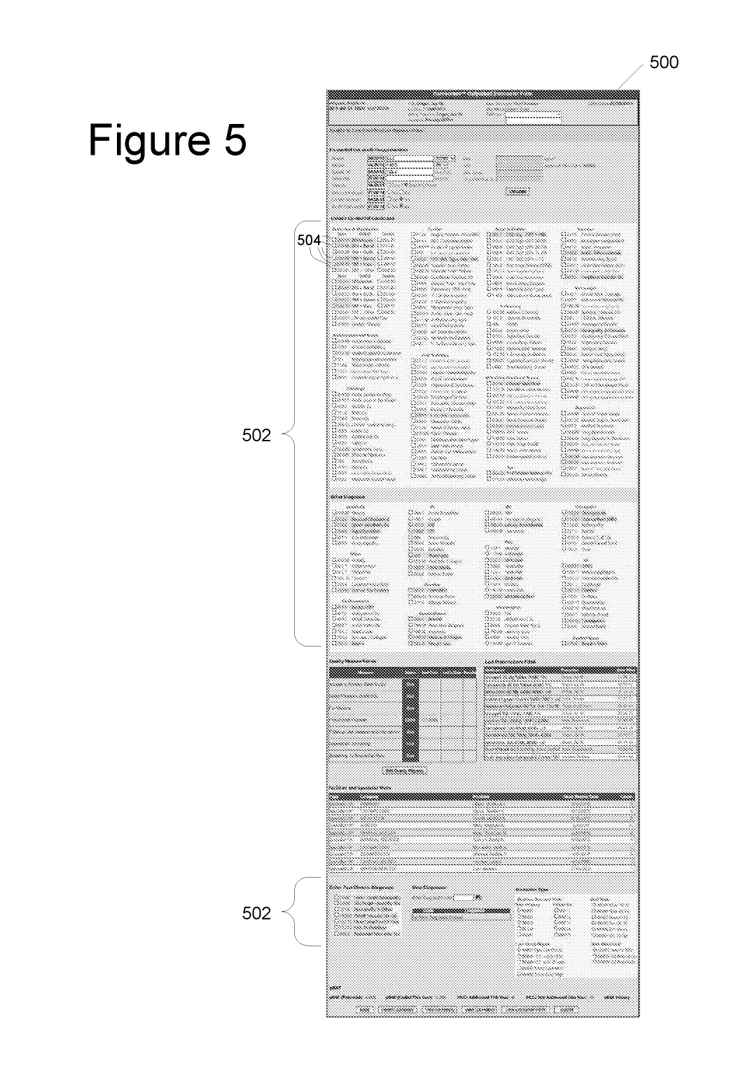

Thus, referring back to FIG. 4, in step 405, the provider 12 may perform the next patient care activity. In step 406, CareScreen™ 90 may then determine whether the activity performed in step 405 is a QVU™ eligible activity. With reference FIG. 5, a diagram of an exemplary patient encounter screen used in CareScreen™ 90. In one embodiment, CareScreen™ 90 may present to the provider 12 a patient encounter screen 500, in which the provider may checkmark activities performed by the provider 12 during the patient encounter. The patient encounter screen 500 may include a plurality of fields 502 that can be checkmarked by the primary care provider 12 to indicate that a patient care activity has performed or completed. In one embodiment, as the corresponding field 502 is checkmarked by the provider 12, the determination made by CareScreen™ 90 in step 406 is performed. CareScreen™ 90 may then transform QVU™ data 350 in the database for the patient encounter to reflect the added QVU™ value for the activity.

Further, in one embodiment, many of the fields 502 may comprise highlighted fields 504 when the patient encounter screen 500 is displayed. The highlighted fields 504 may relate to performance of activities regarding chronic conditions that have not been addressed yet. In one embodiment, some of the highlighted fields 504 may be half or partially highlighted to indicate that the chronic condition has only been partially addressed. Finally, some of the highlighted fields 504 may be grey, which may indicate that the chronic condition has been addressed.

With reference back to FIG. 4, if the result of step 406 is YES, the processing moves back to step 404 to process the QVU™ 350 addition in the database as described above. If the result is NO, the processing moves to stop 408, where the provider 12 determines whether the patient encounter has completed. If not, the processing moves back to step 405 to processing the next provider activity. If the result of step 408 is YES, then CareScreen™ 90 may allow the provider begin a new session for the next patient 10.

At the end of each month, quarter, year, or specified time period, the provider 12 may be awarded monetary incentives based on the number of accumulated QVU™ s 350 for the provider 12.

In general, only 3-5% of providers (even if educated appropriately) adopt best practices without any further incentives, but the inventor has found that the majority of providers will adopt these desired changes if prompted in real time, and if appropriate incentives are provided. Data has shown that when physicians are paid through QVU™ based systems for their time, the use of CareScreen™ 90 and the frequency of desired clinical, quality, risk-reducing and cost saving measures are increased. In addition to multiple specific measures improving, the total medical expense (TME) budget surpluses (savings compared to expected budgets) are directly proportional to the frequency that providers use CareScreen™ 90 and do QVU™ activities.

In summary, effective use of CareScreen™ 90 with QVU™ based systems can (1) improve the quality of care delivered; (2) reduce healthcare delivery costs; (3) improve the management of chronic disease; (4) prevent unnecessary hospital readmissions and other post-acute costs; (5) improve beneficiary and provider satisfaction; (6) manage financial and other risks for care delivered, and (7) improve performance in global payment, bundled payment, and other Fee-For-Value (FFV) arrangements, and thus improving market positions for health systems, and preparing providers for the future.

Other embodiments have further features. For example, and not by way of limitation, the screen of FIG. 5 may further provide QVU™ counts at the bottom of the screen, or at on home screen, for the provider who is logged in. The system may further include an outpatient encounter form, and if electronic medical record (EMR) software is included in the same system, data from the EMR may be imported. On the screen in FIG. 5, yellow highlights may be included to indicate a chronic condition that a provider has not yet addressed, and a half highlighted field may mean that the condition may have only been partially addressed. Grey highlights may mean that the chronic condition has been addressed. Further, even if fields are not highlighted, the system may display most common chronic conditions that the care provider should nevertheless keep in mind during a patient encounter. Finally, a dashboard may be provided that tells a provider how their QVU™ fund is doing.

The various embodiments described above are provided by way of illustration only, and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A computerized system for rewarding medical care provider behavior, comprising:
a server having a processor;
a first set of computer instructions executable on the processer for assigning one or more value units according to predictive value of tasks performed by a medical care provider;
a second set of computer instructions executable on the processor for presenting a screen to the medical care by which the medical care provider may record tasks that are performed;
a third set of computer instructions executable on the processor for rewarding the one or more value units for each task that is performed; and
a fourth set of computer instructions executable on the processor for recording the rewarded one or more value units, and for determine compensation for the medical care provider based on the number of value units that are rewarded.

2. The system of claim 1, wherein the compensation based on rewarded value units is in addition to any fee-for-service payments made to the medical care provider.

3. The system of claim 1, wherein the first set instructions are further for assigning the value points to tasks according to one or more database modules from which statistical data is ascertained to form the relative predictive value of each task.

4. The system of claim 3, wherein the statistical data is of the type selected from the group consisting of pharmacy usage and suggestions data, a referral and admission patterns data, and care coordination data.

5. The system of claim 1, wherein the tasks are each of a type selected from the group consisting of: review disease registry/quality metrics, review pharmacy data and suggestions, look at messages from case managers, chart reviewers, auditors, and/or medical directors.

6. A method for rewarding medical care provider behavior, comprising:
assigning one or more value units according to predictive value of tasks performed by a medical care provider;
presenting a screen to the medical care by which the medical care provider may record tasks that are performed;
rewarding the one or more value units for each task that is performed;
recording the rewarded one or more value units; and
determining compensation for the medical care provider based on the number of value units that are rewarded.

7. The method of claim 6, wherein the compensation based on rewarded value units is in addition to any fee-for-service payments made to the medical care provider.

8. The method of claim 6, wherein the strep of assigning the value points to tasks is according to one or more database modules from which statistical data is ascertained to form the relative predictive value of each task.

9. The method of claim 8, wherein the statistical data is of the type selected from the group consisting of pharmacy usage and suggestions data, a referral and admission patterns data, and care coordination data.

10. The method of claim 6, wherein the tasks are each of a type selected from the group consisting of: review disease registry/quality metrics, review pharmacy data and suggestions, look at messages from case managers, chart reviewers, auditors, and/or medical directors.
